(19) United States
(12) Patent Application Publication
(10) Pub. No.: US 2015/0272081 A1
(43) Pub. Date: Oct. 1, 2015

(54) ARRANGEMENT AND METHOD FOR FEEDING ANIMALS

(71) Applicant: DELAVAL HOLDING AB, Tumba (SE)

(72) Inventor: Fernando MAZERIS, Tumba (SE)

(21) Appl. No.: 14/730,335

(22) Filed: Jun. 4, 2015

Related U.S. Application Data
(63) Continuation-in-part of application No. 10/581,924, filed on Jun. 7, 2006, now Pat. No. 9,091,644.

(30) Foreign Application Priority Data
Jan. 13, 2004 (SE) 0400047-4

(51) Int. Cl. A01K 5/02; A23K 1/18; A23K 1/00; B01F 15/02; B01F 15/00

(52) U.S. Cl. CPC A01K 5/0275; B01F 15/0216; B01F 15/0024; B01F 15/00272; A23K 1/001; A23K 1/1813; B01F 2215/0008

(57) ABSTRACT

An arrangement (12; 16) for feeding animals on a farm comprises an on-farm analyzer device (13; 17) provided for measuring, e.g. at least on a daily basis, the amount of a constituent of solid feed to be fed to said animals, and a feeding device (14; 18) provided for feeding said animals, wherein the feeding depends on the result of said measurement, and the amount of the constituent of solid feed is measured immediately prior to the feeding of said animals. By the arrangement, a proper solid feed mix with a balanced composition can be given to the animals.

### TECHNICAL FIELD OF THE INVENTION

The present invention generally relates to farming, and more specifically the invention relates to an arrangement and a method for feeding animals.

### DESCRIPTION OF RELATED ART AND BACKGROUND OF THE INVENTION

Feed costs comprise 40-50% of the cost of milk production. Implementation and management of feeding systems to sustain high levels of milk production and control feed costs are crucial to the profitability of expanding dairies. Considerations regarding nutritional demands of the herd (including grouping), ration management (includes analysis of the feed, cost and availability), feed preparation and transport, feed distribution and consumption control have to be made.

In the US total mixed ration (TMR) is the predominant method of feed delivery on larger farms. The cows are grouped according to their level of milk production and body condition. Each group is then fed with total mixed ration feed independently to reduce over-feeding of nutrients and therefore feed costs. In Europe, on the other hand, the farms are smaller, and typically, the animals have unlimited supply of roughage, whereas concentrate and optionally minerals, vitamins, and trace elements are given individually to each animal.

The quality of anaerobically fermented or ensiled feed is dependent on the quality of the crude feed, the conditions of ensiling, and the conditions of storage of the ensiled feed. For instance, aerobic deterioration of ensiled feeds is detrimental to the milk production. Aerobic microorganisms such as yeasts, molds and certain bacteria metabolize the highly-digestible fraction of the dry matter and can account for high losses of dry matter.

Attempts have been made to increase the efficiency of feed utilization and milk production by using various formulations and feed supplements. Despite continued improvement in the development of dairy cattle feed rations, it is desirable to further increase the efficiency of feed utilization and milk production by dairy cattle.

### SUMMARY OF THE INVENTION

In order to obtain information of the composition of the ensiled feed, samples may be taken and sent to a laboratory for analyze, and the amounts of various constituents may be derived. By such knowledge a more precise feeding can be performed. However, to obtain a more optimum feeding of animals in terms of feed composition, feed costs and milk production, such a method may not be sufficient. It may for instance be too long delays between the preparation of the sample and when analyze results are received, and samples may be taken too rarely. For instance, the composition of the feed, especially ensiled feed, may vary over time, and as a result the animals may be over or underfed with some constituents of the feed.

It is therefore an object of the present invention to provide an arrangement and a method for feeding animals on a farm, which are more precise, and which can reduce the feeding costs and increase the quantity and/or quality in milk production.

It is a further object of the invention to provide such an arrangement and method, which can be fully automated, and which can be coupled to a computer-based managing and control device for overall management of the animals on the farm.

It is still a further object to provide such an arrangement and method, which are uncomplicated, reliable, of low cost, and easy to implement.

These objects, among others, are according to the present invention attained by arrangements and methods as specified in the appended claims.

It has been established that that the composition of feed, particularly but not solely ensiled feed, varies quite much from day to day, and even from time to time during the day, and that these variations naturally affect the amounts or balance of various nutrients given to the animals in an adverse manner when feeding with fixed rations, and consequently also the milk production is deteriorated.

Further, the composition of feed may vary from spot to spot within a feed storage arrangement such as a fodder silo depending on parameters such as temperature, humidity, and oxygen supply of the immediate environment of the feed at the particular spot. That is, different portions of the feed may have different compositions.

By the provision of an on-farm analyzer device, which measures at least on a daily basis the amount of a Constituent of solid feed to be fed to the animals, and a feeding device, which feeds the animals depending on the measured amount of the constituent of the solid feed, a more precise feeding can be effectuated. Preferably, feed is analyzed at different locations in the feed storage arrangement that stores the feed.

Preferably, the amounts of several constituents, such as e.g. protein content, dry content, and fiber content, particularly neutral detergent fiber (NDF) of the solid feed, are monitored. Measurements may be effectuated immediately prior to each feeding of the animals.

The on-farm analyzer device, which may be a spectroscopic device for quantitative chemical analysis such as e.g. a near infrared (NIR) instrument, measures advantageously the amount of the constituent of the solid feed immediately prior to each feeding of the animals to obtain a real time measurement of the instantaneous composition of the solid feed. It is noticed that the instrument may be located anywhere on the farm, and it may be arranged for manual as well as for automatic measurement.

The amount of suitable feed may be calculated to achieve maximum profit, maximum milk production, or milk of a desired quality. The feeding arrangement is adapted to be implemented in a total mixed ration (TMR) feeding program with group-wise feeding of the animals, or in an arrangement wherein the animals have supply of partial mixed rations (PMR) of feed, including ensilage and concentrate, and wherein the animals are fed with additional concentrate feed individually and depending on the measured amount of the constituent of the solid feed. Alternatively, the animals are grouped in different groups e.g. according their milk production (if the animals are milk producing animals) and body condition, and wherein different groups of animals are fed with roughage or ensiled feed independently, and optionally depending on the measured amount of the constituent of the solid feed, and the animals are fed with concentrate feed on an individual basis and depending on the measured amount of the constituent of the solid feed.

Thus, the present invention may be utilized for feeding of a complete herd of animals, for feeding different groups of animals differently, as well as for feeding each single animal of the herd independently depending on the measured amount of the constituent of the solid feed.

In one advantageous embodiment a computer-based processing and control device is provided for the management of the animals including controlling of the feeding of the animals, and comprises a database including updated information regarding feed consumption by the animals. The processing and control device is connected to receive the respective measured amounts of the constituent of the solid feed from the on-farm analyzer device, and calculates a suitable amount of solid feed of a suitable composition to be fed to the animals based on the measured amount of the constituent of the solid feed and the updated information comprised in the database. Finally, the processing and control device indicates to the feeding device the calculated amount of suitable feed to be fed to the animals. The feeding arrangement may in this manner be fully automatic.

In order to determine the actual feed consumption by the animals, individually, group-wise or totally by the complete herd, a device, preferably a weighing machine or an optical device with image processing capabilities is provided for measuring in connection with each of the feedings, the actual amount of feed consumed by the animals. The feeding of the animals may then be modified according to their previous actual feed consumption.

Further, devices, methods and/or means may be provided for (i) analyzing the milk from the animals provided that the animals are milking animals, e.g. for determining content of fat, protein, lactose, solids-not-fat and somatic cells, urea, or BHB, (ii) analyzing the manure from the animals, and analyzing the body condition of the animals, e.g. for determining the weight and health of the animals. The animals can then be fed depending on some or all of the above data on an animal individual, or group-wise basis.

In addition, according to a further aspect of the present invention an analyzer device is provided on a farm housing animals. The analyzer device is provided to measure the amount of a constituent of solid feed to be fed to the animals on the farm; and includes means provided to transfer the measured amount of the constituent of the solid feed to a feeding device provided for feeding the animals depending on the measured amount of the constituent of the solid feed.

Further characteristics of the invention and advantages thereof, will be evident from the following detailed description of preferred embodiments of the present invention given hereinafter and the accompanying FIG. 1, which is given by way of illustration only and thus, is not limitative of the present invention.

### BRIEF DESCRIPTION OF THE DRAWINGS

FIG. 1 displays schematically a preferred embodiment a feeding system according to the present invention.

### DETAILED DESCRIPTION OF PREFERRED EMBODIMENTS

In the following detailed description the animals are cows. However, the invention is not limited to cows, but is applicable to any animals having the capability to produce large quantities of milk, such as sheep, goats, horses, etc., as well as to beef cattle, and the like. In the latter instance, the descriptions below regarding milk production, milk control, milk analyze etc. can be disregarded.

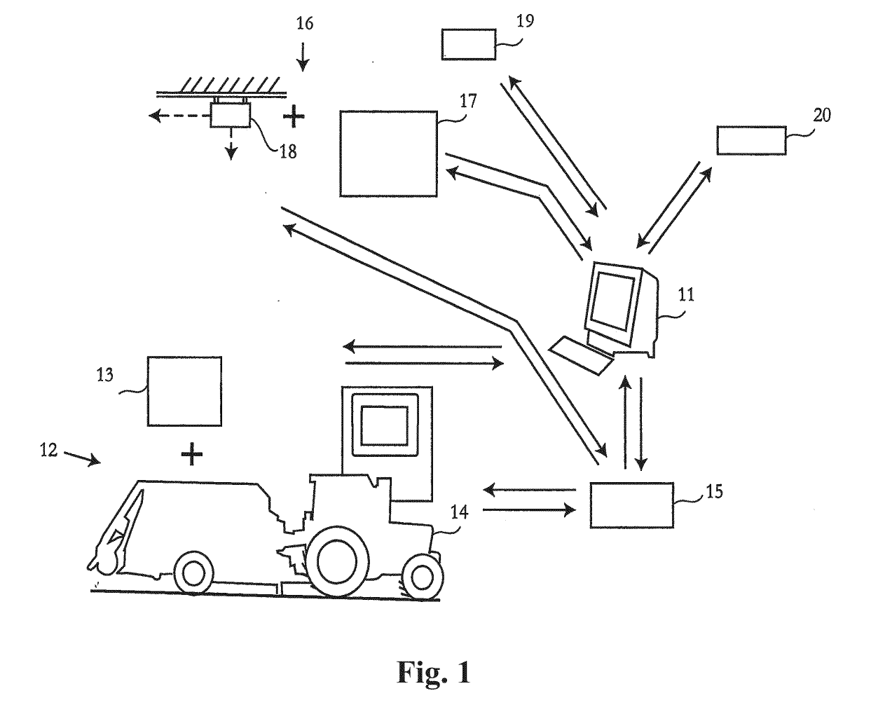

A preferred embodiment of a complete system for feeding cows on a dairy farm according to the present invention is schematically illustrated in FIG. 1.

A computerized cow managing device 11 is provided for the management and control of the cows on the dairy farm. The cow managing system 11 may control and monitor milking, feeding, milk inspection, milk sampling, cow traffic, etc. in an area wherein the cows are walking about freely. To this end, the cow managing system 11 typically comprises a microcomputer, suitable software, and a database including information of each of the cows on the dairy farm, such as e.g. when the respective cow was milked last time, when she was fed last time, how much she was fed last time, her milk production her health, etc.

A first inventive arrangement for feeding the cows on the dairy farm is indicated by reference numeral 12 and comprises an on-farm analyzer device 13 and a feeding vehicle 14.

The on-farm analyzer device 13 is provided for analyzing at least on a daily basis, the composition of solid feed to be fed to the cows and for determining the amount of one or several constituents of the solid feed. The solid feed may include roughage, grass, grain and corn, or any kind of ensiled feed, and the one or several constituents, of which the amount is determined, may include any of protein, dry matter, and fiber, particularly neutral detergent fiber (NDF). Other constituents of the solid feed that can be measure include moisture, fat, starch, TKN, crude fiber, acid detergent fiber (ASF), and lignin according to relevant ISO, EC and AOAC standards. Still other constituents of solid feed to be measured include vitamins and minerals.

The on-farm analyzer device 13 may measure the amount of the solid feed constituent several times per day if appropriate, e.g. immediately prior to each of the feeding instants.

Alternatively or additionally, the on-farm analyzer device 13 may analyze feed stored at different locations in a silo, or in different feed supply or storage devices.

The on-farm analyzer device 13 is preferably a spectroscopic device for quantitative chemical analysis, and more preferably a near infrared (NIR) instrument based on e.g. a near infrared reflectance spectroscopy technique. Documents describing near infrared (NIR) instruments for use in the present invention include the International Patent publication No. WO 01/14857 A1, Near Infrared spectroscopy, Edited by R. K. Cho and A. M. C. Davies, Proceedings of the 10^{th} International Conference, NIR Publications, pp 23-28, 2001; and Comparison of linear and non-linear near infrared calibration methods using large forage databases, P. Berzaghi et al., pp 107-111, as well as references mentioned therein, the contents of which being hereby incorporated by reference.

The latter article describes comparison of various calibration methods using large forage databases. The amount of forage data growths fastly and will provide for the development of better global calibration methods in order to obtain more accurate absolute values of the amounts of different constituents of the solid feed.

The on-farm analyzer device 13 can be an apparatus existing commercially today, but preferably a simplified, faster and cheaper apparatus designed for the field should be used. By means of having the analyzer device 13 on the farm for in-situ measurements, real time or near real time values of the composition of the solid feed can be provided.

The on-farm analyzer device 13 may comprise different apparatuses for measurements of different constituents. Preferably, the on-farm analyzer device measures the composition of all feed ingredients to provide for a more accurate ration balancing so that the cows can maximize their production.

The feeding vehicle 14 of the feeding arrangement 12 is provided for feeding the cows, at each instant, depending on the measured amount of the one or several constituents of the solid feed. The feeding vehicle may be a truck or trailer filled with the solid feed, and the on-farm analyzer device 13 is advantageously mounted at the truck or trailer for measuring the amount of the solid feed constituent.

A feed management module 15 is provided as a separate module in the computerized cow managing device 11, as a stand-alone device, or as being incorporated in the arrangement 12. The feed management module 15, which in any case is connected to communicate with the cow-managing device 11 and the arrangement 12, fetches updated information regarding milk production and feed consumption by the cows and the respective measured amounts of the solid feed constituent. The feed management module 15 calculates repeatedly (prior to each feeding instant) an amount of feed to be fed to the cows based on, at each instant, the measured amount of the solid feed constituent and the updated information, and indicates, preferably to the arrangement 12 or the feeding vehicle 14, the calculated amount of feed to be fed to the cows at each instant.

By means of the inventive arrangement 12, more precise feeding can be effectuated. An exact amount of feed ingredients and nutrients can be given to each cow, while the feed costs are kept at a minimum and the milk production is kept at a maximum.

It shall be noted that the feeding vehicle 14 may be provided for feeding the cows with mixed feed with a balanced composition, at each instant, depending on the measured amount of the solid feed constituent, or that the feeding vehicle 14 is provided for feeding the cows with roughage, ensilage, concentrate feed or other feed additive such as e.g. minerals and vitamins, at each instant, depending on the measured amount of the solid feed constituent. In the former instance, the feed mix is given in accurate amounts at each instant to compensate for any variations as measured so that the cow will receive the necessary nutrients. In the latter instance, some feed ingredient may be given in suitable amounts, at each instant, to compensate for any variations in the composition of the solid feed mix.

The system of FIG. 1 comprises also a second inventive feeding arrangement 16. The second arrangement 16 comprises an on-farm analyzer device 17 and a feeding device 18. The on-farm analyzer device 17 may be identical with or similar to the on-farm analyzer device 13 of the first feeding arrangement 12. However, the feeding device 18 is provided as a feed wagon, preferably an in-door feed wagon mounted on a rail in a ceiling, for automatic feeding of the cows. The second arrangement 16 is also connected to the feed management module 15 and to the computerized cow managing device 11, and operates similar to the arrangement 12. However, here a fully automated management and feeding system is provided which may handle ration calculation and feeding completely automatically.

The arrows in FIG. 1 indicate communication links between the different parts of the inventive system for feeding cows. Provided that each component is provided with a microcomputer and transceiver (or directly connected cable) the communication as well as the operation of the system can be fully automated.

It shall be appreciated by the man skilled in the art that the present invention may comprise only one of the feeding arrangements 12, 16. Likewise, the two feeding devices, the feeding vehicle 14 and the feed wagon 18, may be connected to a single on-farm analyzer device and to obtain the measured amounts of solid feed constituents from this single on-farm analyzer device.

The present invention is suitable for use in combination with TMR (total mixed ration) feeding programs, PMR (partially mixed ration programs), or other modified feeding programs.

TMR, or complete rations, are defined as those with all the roughage, ensilage, concentrate and grain ingredients blended together, formulated to specific nutrient concentration, and fed free choice. TMR has become very attractive in the US for large dairy farms, e.g. those housing several hundred and up to several thousand cows. The main advantages of TMR feeding are that cows consume the desired proportion of feed when two or more feed ingredients are offered; feed efficiency improves; it allows for greater use of unpalatable feeds, NPN sources, and commodity feeds; and it allows for greater accuracy in formulating and feeding. The potential disadvantages include that TMR requires a significant equipment investment in a mixer; the cows have to be grouped into two or more groups; rations must be carefully formulated and continually checked; and pasture feeding and large amounts of long hay are difficult to incorporate into rations.

Dividing cows into production strings is a critical factor for the success of TMR feeding. The cows are typically grouped in different groups according their milk production and body condition. For instance, the cows may be grouped into the following groups: fresh cows, high producing older cows, high production first calf heifers, and cows with low or excess body condition. In larger herds more groups can be defined to obtain about 100 cows in each group.

The feeding arrangement 12 (and/or 16) of the present invention can be used for feeding different groups of cows with total mixed rations of feed, including the analyzed feed, independently, and, at each instant, depending on the measured amount of the solid feed constituent. The ration formulation (i.e. the relative amount of the various ingredients in the total mixed ration) as well as the total amount of feed to be given to the cows can be determined based on result of the on-farm analyzer device 13 (and/or 17) of the present invention.

PMR is used frequently throughout Europe, particularly at smaller dairy farms, and in this program at least one component of the feed is given to the cows on an individual basis. Typically, the cows may have unlimited supply of roughage, whereas concentrate feed and/or feed additives (including grains, minerals and vitamins) are given to the cows individually. The advantage is that high cost feed ingredients (e.g., protected fats, high bypass protein supplements, special mineral packs) can be specifically targeted to individual cows. The disadvantage of additional grain feeding is excessive amounts can unbalance the feeding balance reducing fiber and forage intakes.

While using the present invention in the above-identified PMR program, the feed device 18 is provided for feeding each of the cows with concentrate feed individually, and, at each instant, depending on the measured amount of the solid feed constituent. E.g., if it is noted that the cows obtain too small quantities of a particular nutrient from the feed due to low contents of it in silage, higher quantities of the nutrient may be added to the concentrate. Also, since the concentrate is given to the cows individually, the concentrate can be given in different amounts to different individuals.

In a modified PMR version, the cows are grouped in different groups e.g. according their milk production and body condition, and cows of different groups are given different partially mixed rations of feed including ensilage, whereas the concentrate feed and/or feed additives are given to the cows, as above, individually. Here the feed device 18 of the present invention is provided for (i) feeding different groups, of cows with the PMR feed (including ensilage) independently, and at each instant, depending on the measured amount of the solid feed constituent, and (ii) feeding the cows with concentrate feed or feed additives on an individual basis, and, at each instant, depending on the measured amount of the solid feed constituent.

In another feeding program each cow is given in principle all its feed (solid and optionally liquid) on an individual basis. Automatic feeding stations known in the art may be used to give each cow, after the cow has been identified by an automatic identifying device, precise and accurate feed rations at each instant, where these precise and accurate feed rations are determined at each instant depending on the measured amount of the solid feed constituent.

It shall be noted that the feeding arrangements 12, 16 of the present invention may also comprise apparatuses (the devices 13, 17 or others) capable of analyzing mixed feed and determine various constituents or ingredients in the mix, wherein the feeding arrangements 12, 16 may base their feeding on the result of such analysis.

Measurements may be performed on samples of the individual ingredients of a food mixture before the different ingredients are mixed together, wherein the mixing is performed based on the result of the measurements of the samples. Certain parameters, such as the humidity value, of the different ingredients will directly affect the amount of a specific ingredient in the food mix, whereas other parameters, such as protein, has to deviate to a certain degree from an acceptable level before the amount of the ingredient in question in the mix is changed. The percentage of the different ingredients in a mixture shall, however, not be changed to often since problems may arise such as the digestion of the animals.

It shall be appreciated by the man skilled in the art that the feeding may be performed based on the last measured amount of feed constituent, or on some average of a number of measurements performed.

In order to obtain even more precise and accurate feeding of the cows, further information of the feed given to the cows and of the cows themselves are required. In order to fulfill such requirements, the present invention features a device 19, preferably a weighing machine or an optical device with image processing capabilities, provided for measuring in connection with each of the feedings, the actual feed consumption by the cows. This may be performed on a cow individual basis, for groups of cows, or commonly for a complete herd. The feeding of the cows, individually, group-wise or commonly for the herd, can then, at each instant, be dependent on measured actual feed consumption by the cows.

Further, a device 20, schematically indicated in FIG. 1, is provided for analyzing milk from the cows, for analyzing the condition of the cows, and/or for analyzing manure from the cows. Milk analyzer apparatuses are known in the art. In connection with the milking of the cows, the milk is measured and analyzed to reveal e.g. protein and fat contents, the conductivity, the somatic cell count etc. Some of these milk quality parameters are related to the health of the cows. Other apparatuses for measuring the condition of the cows include activity meters, weighing devices, and inspection devices. Evaluation of manure can provide information on rumen function and digestion of the feed ration. Milk, cow health and manure evaluation can thus help to diagnose areas for improvement in both ration formulation and feed management. Therefore, the feeding of the cows, individually, group-wise or commonly for the herd, can, at each instant, be dependent on the data related to the milk produced by the cows, to the condition or health of the cows, and to the manure of the cows.

1. A feeding system for feeding animals on a farm, comprising:
an on-farm analyzer device that, in-situ on the farm, i) measures a respective amount of each of plural constituents in a solid feed mix to be fed to the animals on the farm, and ii) provides a result of the respective measurements of the amount of each of the constituents in the feed mix;
a feeding device that feeds said feed mix to the animals; and
a control device, wherein the control device i) controls the analyzer device to measure the amount of the constituents of the feed mix at least once a day prior to the feeding device feeding said feed mix to the animals, and ii) based on the result of the measurement of the amount of the constituents in the feed mix, controls an amount of feed mix that the feeding device feeds, during said feeding, to the animals.

2. The system of claim 1, wherein the amount of the constituents includes at least two of a protein content, a dry matter content, a fiber content, and a neutral detergent fiber (NDF) content.

3. The system of claim 2, wherein the control device i) controls said analyzer device to further measure an amount of humidity of the feed mix, and ii) based on the measured humidity, controls said feeding device in measuring the amount of the feed mix fed to the animals.

4. The system of claim 1, wherein the control device i) controls said analyzer device to further measure an amount of humidity of the feed mix, and ii) based on the measured humidity, controls said feeding device in measuring the amount of the feed mix fed to the animals.

5. The system of claim 1, wherein, based on i) the result of the measurement of the amount of the constituents in the feed mix and ii) different nutritional needs of each of plural different ones of the animals, the control device controls the feeding device to feed each of said different animals as respective different amount of the feed.

6. The system of claim 1, wherein,
the analyzer device measures the constituents and provides the results in real time or near real time,
a first apparatus that measures of a first of the plural constituents in the feed mix, and
a second apparatus that measures of a second of the plural constituents in the feed mix.

7. The system of claim 1, wherein said analyzer device comprises a spectroscopic device for quantitative chemical analysis.

8. The system of claim 2, wherein said analyzer device comprises a spectroscopic device for quantitative chemical analysis.

9. The system of claim 1, wherein said analyzer device comprises a near infrared (NIR) instrument.

10. The system of claim 1, wherein the control device is a computer-based processing and control device provided for managing of said animals including controlling of the feeding of said animals, wherein said computer-based processing and control device includes:
a database including updated information regarding feed consumption by said animals;
is connected to receive said respective measured amounts of said constituent of said feed mix;
is provided to calculate the amount of feed mix to be fed to said animals based on the performed measurements and said updated information included in said database; and
is connected to indicate to said feeding device said calculated amount of the feed mix to be fed to said animals, and
wherein the control device is configured to control said feeding device to feed said animals with the feed mix having a balanced composition depending on the performed measurements.

11. The system of claim 1, wherein said feeding device is comprised of a vehicle filled with said feed mix, and said analyzer device is provided at said vehicle for measuring the amount of said constituents in the feed mix prior to feeding the animals.

12. The feeding system of claim 1, wherein,
the on-farm analyzer device further, in-situ on the farm, i) measures an amount of one of the constituents in respective samples of individual ingredients of a food mixture that make up the feed mix, and ii) in real time or near real time, provides a further result based on the measurement of the amount of the constituent in the samples, wherein the amount of the constituent includes at least one of a protein content, a dry matter content, a fiber content, and a neutral detergent fiber (NDF) content;
further comprising a mixing device provided that i) measures an amount of each of the individual ingredients of the food mixture, and ii) mixes the measured amount of each of the individual ingredients of the food mixture to form the feed mix, the measuring of amount of each of the individual ingredients of the food mixture being based on the further result of the measurement of the constituent in the samples by the analyzer device,
wherein the control device controls the analyzer device to measure the amount of the constituent in the samples of the individual ingredients of the food mixture at least once a day prior to the mixing device mixing the measured amount of each of the individual ingredients of the food mixture into the feed mix and the feeding device feeding said feed mix to the animals.

13. A method of feeding animals on a farm, comprising:
operating a control device to
1) control an on-farm analyzer device, in-situ on the farm, to i) measure a respective amount of each of plural constituents in a solid feed mix to be fed to the animals on the farm, and ii) provide a result of the respective measurements of the amount of each of the constituents in the feed mix; and
2) control a feeding device to feed said feed mix to the animals,
wherein the control device i) controls the analyzer device to measure the amount of the constituents of the feed mix at least once a day prior to controlling the feeding device to feed said feed mix to the animals, and ii) based on the result of the measurement of the amount of the constituents in the feed mix, controls an amount of feed mix that the feeding device feeds during said feeding to the animals.

14. The method of claim 13, wherein, in the measuring step, the amount of the constituents includes at least two of a protein content, a dry matter content, a fiber content, and a neutral detergent fiber (NDF) content.

15. The method of claim 14, wherein the control device i) controls said analyzer device to further measure an amount of humidity of the feed mix, and ii) based on the measured humidity, controls said feeding device in measuring the amount of the feed mix fed to the animals.

16. The method of claim 14, wherein, based on i) the result of the measurement of the amount of the constituents in the feed mix and ii) different nutritional needs of each of plural different ones of the animals, the control device controls the feeding device to feed each of said different animals as respective different amount of the feed.

17. The method of claim 14, wherein,
the analyzer device measures the constituents and provides the results in real time or near real time,
a first apparatus that measures of first of the plural constituents in the feed mix, and
a second apparatus that measures of second of the plural constituents in the feed mix.

18. The method of claim 13, wherein,
said feed is ensiled feed, and
said analyzer device is a spectroscopic device for quantitative chemical analysis.

19. The method of claim 13, wherein,
said feed is ensiled feed, and
said analyzer device is a near infrared (NIR) instrument.

20. The method of claim 13, wherein the control device is a computer-based processing and control device provided for managing of said animals including controlling of the feeding of said animals, wherein said computer-based processing and control device:
includes a database including updated information regarding feed consumption by said animals;
receives said respective measured amounts of said constituent of said feed mix;
calculates the amount of feed mix to be fed to said animals based on the performed measurements and said updated information included in said database; and
indicates to said feeding device said calculated amount of the feed mix to be fed to said animals, and
controls said feeding device to feed said animals with feed mix having a balanced composition depending on the performed measurements.
